(19) United States
(12) Patent Application Publication
(10) Pub. No.: US 2016/0355162 A1
(43) Pub. Date: Dec. 8, 2016

(54) METHOD OF USING BATTERY PACK FOR ELECTRIC VEHICLE

(71) Applicant: Byung Hyouk KANG, Cheonan-si, Chungcheongnam-do (KR)

(72) Inventor: Byung Hyouk KANG, Cheonan-si, Chungcheongnam-do (KR)

(21) Appl. No.: 15/101,802

(22) PCT Filed: Feb. 27, 2014
(86) PCT No.: PCT/KR2014/001614

§ 371 Date: Jun. 3, 2016

(30) Foreign Application Priority Data
Dec. 3, 2013 (KR) 10-2013-0149024

(51) Int. Cl. B60S 5/06; B60L 11/18

(52) U.S. Cl. CPC B60S 5/06; B60L 11/1822; B60L 11/1824; B60L 11/1861; B60L 11/1868

(57) ABSTRACT

Disclosed herein is a method of replacement, management, and power transmission using a battery pack replacement system for an electric vehicle with an ESS. The method includes detaching a discharged battery pack from the electric vehicle, delivering the detached discharged battery pack to a charging/discharging line, charging and storing the discharged battery pack, primarily checking a buffer capacity of the battery pack, classifying the battery pack as a buffer battery pack for replacement if, as a result of the check, the buffer capacity of the battery pack is equal to and greater than a first buffer capacity reference, moving the battery pack to an energy storage-dedicated line if, as a result of the check, the buffer capacity of the battery pack is smaller than the first buffer capacity reference, secondarily checking the buffer capacity of the battery pack, and classifying the battery pack as an ESS-dedicated battery pack.

### BACKGROUND OF THE INVENTION

[Technical Field]

The present invention relates to a method of using a battery pack for an electric vehicle, wherein a discharged battery pack for an electric vehicle is replaced with a charged battery pack, a plurality of battery packs is separately stored for a replacement use and for a storage use, and power is transmitted if necessary.

[Description of the Related Art]

As global warming is accelerated, a weather disaster is generated and life is endangered by a serious climate change. Strong control on carbon dioxide is globally spoken with one voice. The auto industry has entered a new phase in accordance with such environmental and social requests. There is a growing interest in an eco-friendly vehicle capable of minimizing the discharge of exhaust gas that is discharged from an internal combustion engine vehicle.

Such an eco-friendly vehicle may be classified into a Hybrid Electric Vehicle (HEV) in which an internal combustion engine and electric power are combined and used, an Electric Vehicle (EV) using only electric power, and a Fuel Cell Electric Vehicle (FCEV) using a fuel cell, depending on their power sources.

In line with a worldwide trend toward a reduction of the discharge of carbon dioxide, in Korea, it is expected that the demand and supply of electric vehicles will be suddenly increased due to the mass production of electric vehicles.

Furthermore, an electric vehicle, such as a Plug-in-Hybrid Electric Vehicle (PHEV), has advantages of low energy consumption and low air pollution. In particular, such an electric vehicle plays an important role in solving environmental pollution and energy reduction problems in the paradigm of a smart grid. As electric vehicles are suddenly used, active research has been carried out on the influence of a load of an electric vehicle on a power grid.

A conventional charging system for an electric vehicle, as shown in FIG. 1, includes a battery pack 10 configured to have a plurality of cells connected thereto depending on necessary electric power, a voltage measurement unit 11 configured to measure voltage of the battery pack 10, a Battery Management System (BMS) 12 configured to uniformly maintain a voltage difference between the cells of the battery pack 10 and a charging circuit 13 configured to convert commercial power into power that can be charged.

The conventional charging system for an electric vehicle was developed to simply charge a battery, but the charging system has rarely been researched for the purpose of replacing a battery pack.

Apart from the charging system, active research is being carried out on an Energy Storage System (ESS) in preparation for a short power supply condition. An ESS is a system for storing power excessively generated from a power plant and supplying the stored power when power is temporarily insufficient. An ESS is suddenly emerging as a scheme for efficiently utilizing a current electric power generation system.

However, research on the battery pack replacement system and research on the ESS for an electric vehicle are separately carried out. Accordingly, there is a need for integrated research on a battery pack replacement system and an ESS based on the same category in which charging is performed by supplying the power battery pack replacement system and the ESS.

(Patent Document 1) KR2013-0071923 10

### SUMMARY OF THE INVENTION

Accordingly, the present invention has been made keeping in mind the above problems occurring in the prior art, and an object of the present invention is to provide a method of using a battery pack for an electric vehicle in a battery pack replacement system for an electric vehicle with an ESS, wherein a plurality of battery packs is charged and stored, a discharged battery pack for an electric vehicle is replaced with a charged battery pack, power is stored through the plurality of stored battery packs and transmitted if necessary, and a vehicle can be driven within a shorter time as compared with a conventional charging method through the replacement of battery packs.

In accordance with an aspect of the present invention, a method of managing battery packs in a system equipped with a replacement system for replacing a battery pack for an electric vehicle and an Energy Storage System (ESS) includes a tenth step S10 of detaching a discharged battery pack 100 from the electric vehicle, an eleventh step S11 of delivering the detached discharged battery pack 100 to a charging/discharging line, a twelfth step S12 of charging and storing the discharged battery pack 100, a thirteenth step S13 of primarily checking a buffer capacity of the battery pack 100, a fourteenth step S14 of classifying the battery pack 100 as a buffer battery pack 100 for replacement if, as a result of the check, the buffer capacity of the battery pack 100 is equal to and greater than a first buffer capacity reference, a fifteenth step S15 of moving the battery pack 100 to an energy storage-dedicated line if, as a result of the check, the buffer capacity of the battery pack 100 is smaller than the first buffer capacity reference, a fifteenth-first step S15-1 of secondarily checking the buffer capacity of the battery pack 100, and a sixteenth step S16 of classifying the battery pack 100 as an ESS-dedicated battery pack 120.

The method further includes a sixteenth-first step S16-1 of thirdly checking a buffer capacity of the ESS-dedicated battery pack 120 after the sixteenth step S16 and a seventeenth step S17 of discarding the battery pack 100 if, as a result of the check, the buffer capacity of the battery pack 100 is smaller than the second buffer capacity reference.

Furthermore, a method of managing battery packs in a system equipped with a replacement system for replacing a battery pack 100 for an electric vehicle and an ESS includes a twentieth step S20 of raising a replacement tool for detaching a discharged battery pack 100 when the vehicle enters the system, a twenty-first step S21 of releasing a locking of the discharged battery pack 100, a twenty-second step S22 of opening a safety device, a twenty-third step S23 of detaching the discharged battery pack 100 and unloading the discharged battery pack 100, a twenty-fourth step S24 of raising a charged battery pack 100 using the replacement tool, a twenty-fifth step S25 of mounting the charged battery pack 100 on the safety device, a twenty-sixth step S26 of fastening the safety device to the charged battery pack 100, and a twenty-seventh step S27 of lowering the replacement tool to its original position.

Furthermore, wherein the charged battery pack 100 includes only a buffer battery pack 110.

Furthermore, a method of using a battery pack 100 for an electric vehicle in a system equipped with a replacement system for replacing the battery pack for the electric vehicle and an ESS includes a determination unit for determining a type of battery pack 100 of the vehicle, a replacement unit for detaching a discharged battery pack 100 from the vehicle or mounting a battery pack on the vehicle, a charging/discharging unit for charging/discharging and storing the discharged battery pack 100, and a transfer unit for conveying the discharged battery pack, detached from the replacement unit, to the charging/discharging unit or conveying the battery pack 100, charged by the charging/discharging unit, to the replacement unit. The method includes a thirty-first step S31 of comparing an amount of power of ESS battery packs 110 with an amount of power to be transmitted when the amount of power to be transmitted that is necessary for an emergent power supply is assigned by a nation power management institution, a thirty-second step S32 of assigning some of the ESS battery packs 110 and the buffer battery packs 120 if, as a result of the comparison, the amount of power of the ESS battery packs 110 is insufficient, and a thirty-third step S33 of converting power of a plurality of the ESS-dedicated battery packs 120 and a plurality of the battery packs for battery 110 that are charged and stored and sending the power according to the assigned amount of power.

Furthermore, the method further includes a (32-1)^{th} step S32-1 of assigning some of the amount of power from the buffer battery packs 120 if the amount of power of the ESS battery packs 110 is insufficient at the thirty-first step S31, and the system further includes a control unit for controlling the time taken to mount a fully charged battery on the electric vehicle according to a ratio of the assigned buffer battery packs 120. The determination unit determines a battery pack using barcode, Bluetooth, or a sensor attached to the battery pack. The ESS-dedicated battery pack 120 and the buffer battery pack 110 are connected in series and in parallel to supply power to a system line.

### [Advantageous Effects]

As described above, in accordance with the present invention, a plurality of battery packs is charged and stored, a discharged battery pack is replaced with a stored charged battery pack, the replaced charged battery pack is mounted on a vehicle. Accordingly, there are advantages in that the method of the present invention can replace a conventional method in which a driver directly charges and replaces a battery pack, a safety accident that may occur when a battery pack is directly charged can be reduced, and time can be reduced because the time taken to replace a discharged battery pack is shorter than the time taken to directly charge a discharged battery pack.

Furthermore, battery packs are classified into a buffer battery pack having a buffer capacity of about 70% or more and an ESS-dedicated battery pack having a buffer capacity of less than about 70%. If the buffer capacity of a buffer battery pack is lowered, the buffer battery pack is classified as an ESS-dedicated battery pack. Accordingly, there is an advantage in that a buffer battery pack having a lower buffer capacity can be reused without being discarded. Furthermore, there is an advantage in that a driver' safety can be improved because battery packs can be replaced in the state in which the driver has not gotten off a vehicle.

Furthermore, there is an advantage in that shortage of electricity in a nation can be overcome to some extent because power charged in ESS battery packs through a power system is transmitted to establishments that require power through system lines when power is temporarily insufficient and power charged in buffer battery packs is transmitted upon emergent power demand.

### BRIEF DESCRIPTION OF THE DRAWINGS

The accompanying drawings described below show exemplary embodiments of the present invention for the purpose of assisting understanding of the present invention with the detailed description of the embodiments. The drawings should not be interpreted to limit the present inventions in any aspect.

FIG. 1 is a diagram schematically showing a conventional system for charging the battery of an electric vehicle.

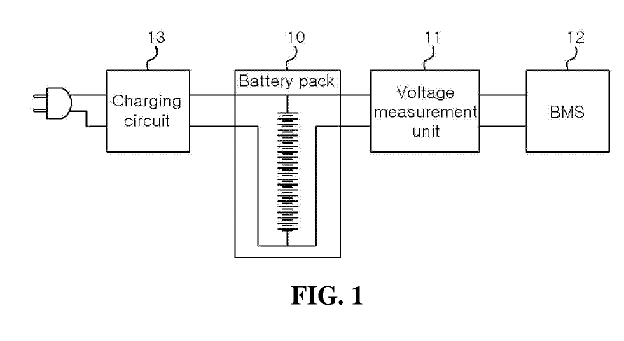

FIG. 2 is a process diagram schematically showing a battery replacement system for an electric vehicle with an ESS in accordance with an exemplary embodiment of the present invention.

FIG. 3 is a side view schematically showing the side of an apparatus for implementing the replacement and charging of a battery in the battery replacement system of FIG. 2.

FIG. 4 is a plan view schematically showing a battery storage unit of FIG. 3.

FIG. 5 is a process diagram for replacing a battery pack for an electric vehicle which has entered a battery replacement system.

FIG. 6 is process diagram for illustrating an ESS shown in FIG. 2.

FIG. 7 shows a power system of FIG. 6.

<Description of reference numerals of
principal elements in the drawings>

| 100: battery pack | |
|---|---|
| 110: battery pack for battery | |
| 120: ESS-dedicated battery pack | |
| 300: replacement device | 310: first transfer device |
| 400: first transfer device | 410: second conveyance device |

500: second conveyance device
510: third conveyance device
520: transfer device
530: charging/discharging device

### DETAILED DESCRIPTION

Hereinafter, some exemplary embodiments of the present invention are described in detail with reference to the accompanying drawings in order for those skilled in the art to be able to readily practice them. In describing an operational principle relating to the embodiments of the present invention, however, when a detailed description of relevant functions or constructions is deemed to make the subject matter of the present invention unnecessarily obscure, the detailed description will be omitted.

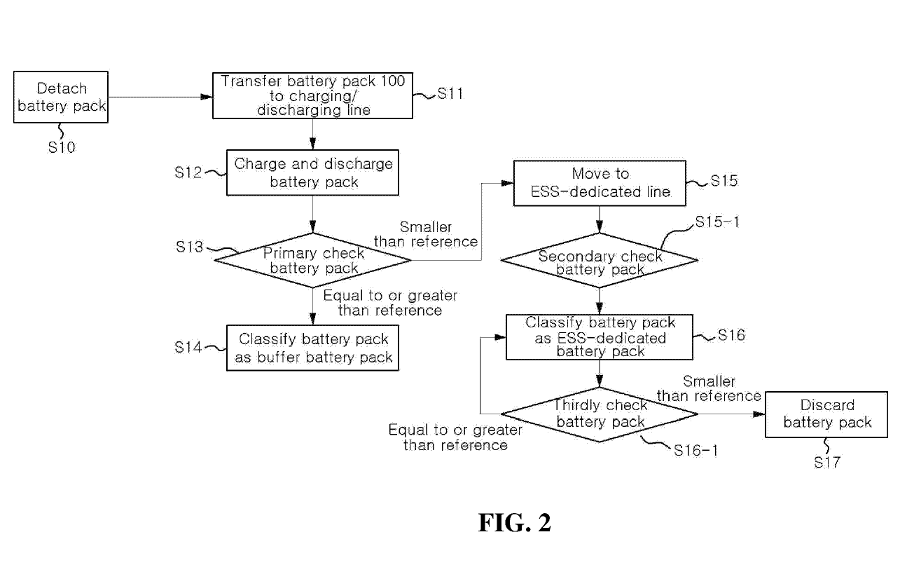

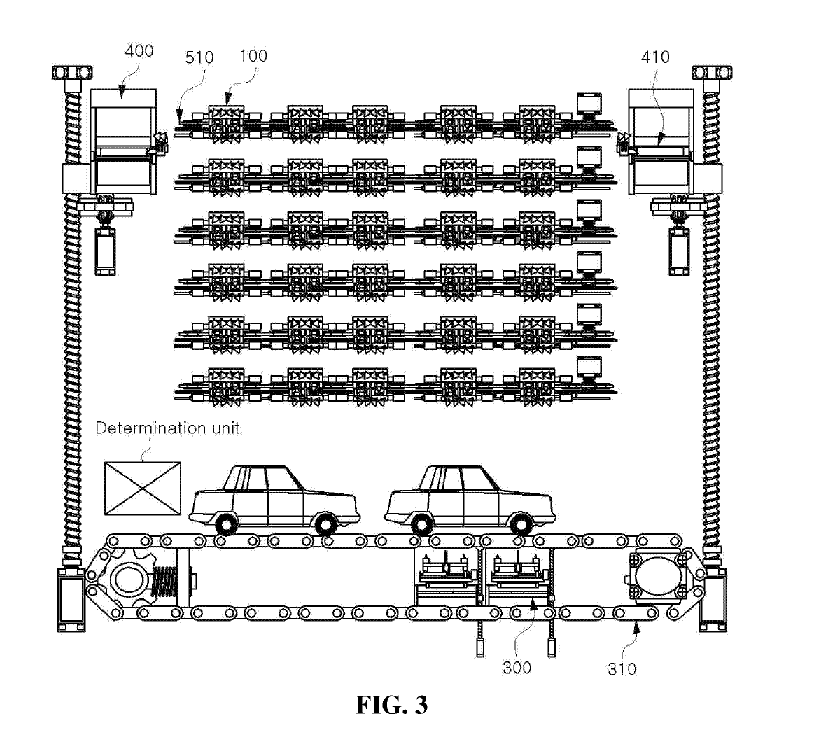

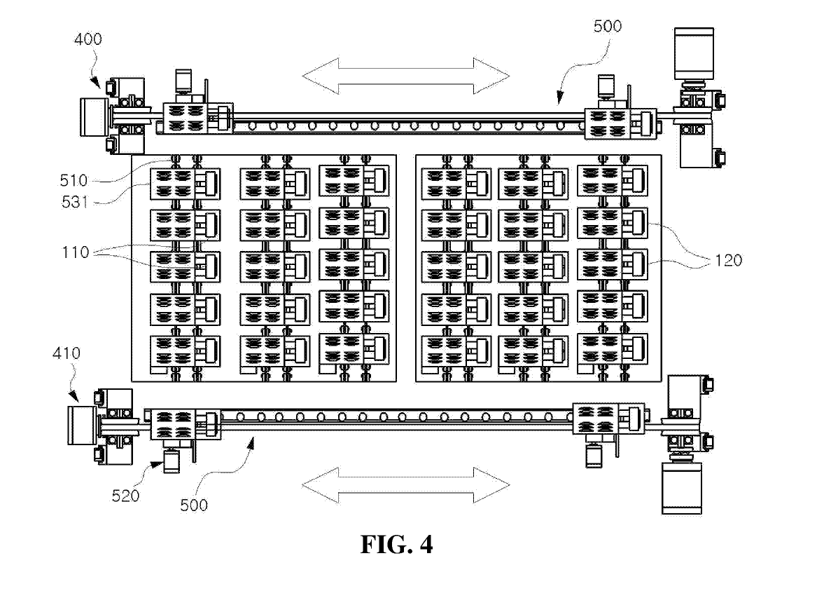

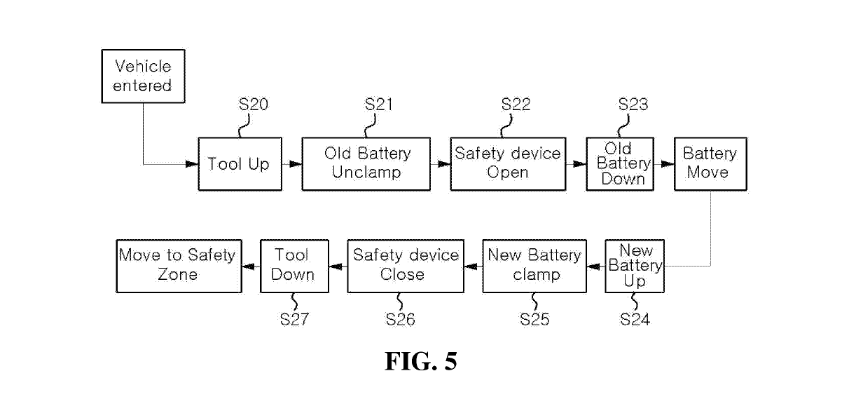

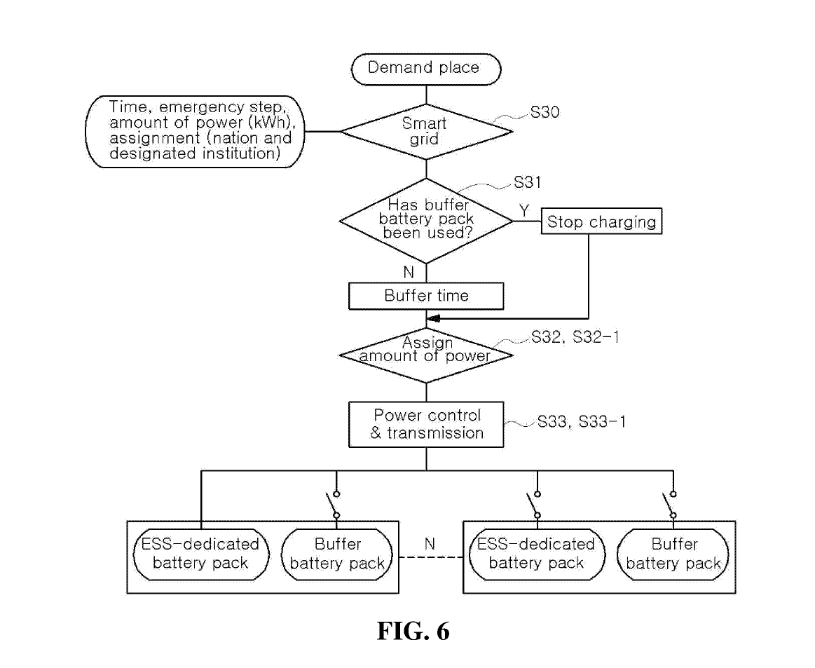

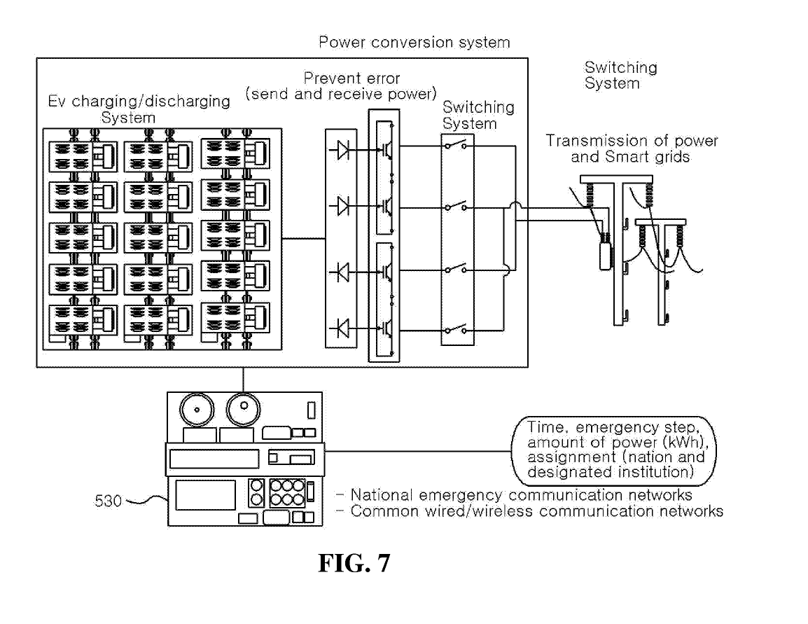

FIG. 2 is a process diagram schematically showing a battery replacement system for an electric vehicle with an ESS in accordance with an exemplary embodiment of the present invention, FIG. 3 is a side view schematically showing the side of an apparatus for implementing the replacement and charging of a battery in the battery replacement system of FIG. 2, FIG. 4 is a plan view schematically showing a battery storage unit of FIG. 3, FIG. 5 is a process diagram for replacing a battery pack for an electric vehicle which has entered a battery replacement system, FIG. 6 is process diagram for illustrating an ESS shown in FIG. 2, and FIG. 7 shows a power system of FIG. 6.

The battery pack replacement system for an electric vehicle with an ESS according to the present invention, as shown in FIG. 2, includes a battery pack replacement system and an Energy Storage System (ESS). The replacement system of the present invention is a system including both a replacement system for replacing a discharged battery pack with a battery pack that has been previously charged and stored without charging the battery of an electric vehicle at an electricity charging point and an ESS for sending electricity using the stored battery pack as energy storage purposes. Hereinafter, the battery pack replacement system and the ESS are separately described.

A schematic process for classifying or discarding battery packs by checking the buffer capacities of the battery packs in the system according to the present invention is shown in FIG. 2.

First, a discharged battery pack 100 is detached from an electric vehicle at step S10.

The discharged battery pack 100 is transferred to a charging/discharging line at step S11.

Next, the battery pack 100 is charged and stored at step S12. Here, the battery pack 100 is fully discharged through a discharging feeding circuit and then fully charged through a charging feeding circuit.

The buffer capacity of the charged battery pack 100 is primarily checked at step S13. Here, a first buffer capacity of the battery pack 100 is assumed to be, for example, about 70%, and the battery pack 100 is primarily classified based on the first buffer capacity.

If, as a result of the check, the battery pack 100 is found to have a buffer capacity equal to or greater than the first buffer capacity, the battery pack 100 is classified as a buffer battery pack 110 at step S14. Here, the classified buffer battery pack 110 is managed by the replacement system so that it can replace the discharged battery pack 100.

If, as a result of the check, a battery pack 100 classified as having a buffer capacity smaller than the first buffer capacity, belonging to the primarily classified battery packs 100, is moved to an energy storage-dedicated line at step S15.

Next, a buffer capacity of the primarily classified battery pack 100 is secondarily checked at step S15-1. Here, the buffer capacity of the battery pack 100 is checked. Accordingly, the amount of power to be transmitted to a power system line can be calculated along with a total amount of charging of all ESS-dedicated battery packs 120 by checking the buffer capacity of each of the ESS-dedicated battery packs 120.

Next, the secondarily checked battery pack 100 is classified as an ESS-dedicated battery pack 120 at step S16.

The battery pack 100 detached from the vehicle is managed as described above.

Thereafter, a buffer capacity of the ESS-dedicated battery pack 120 is thirdly checked at step S16-1. This is for repeatedly checking a buffer capacity reduced while a corresponding battery pack is used as the ESS-dedicated battery pack 120 in real time. Here, the reduced buffer capacity is about 10 to 40%, and the ESS-dedicated battery pack 120 is secondarily classified based on such a second buffer capacity. Here, if, as a result of the check, the ESS-dedicated battery pack 120 is found to have a buffer capacity equal to or greater than the second buffer capacity, a current storage state is maintained and the corresponding battery pack is used as the ESS-dedicated battery pack 120.

If, as a result of the check, the ESS-dedicated battery pack 120 is found to have a buffer capacity smaller than the second buffer capacity, the battery pack 100 is discarded at step S17.

The ESS-dedicated battery packs 120 are managed as described above.

As shown in FIG. 3, such a battery pack replacement system includes a determination unit for determining the type of battery pack 100 of a vehicle using barcode, Bluetooth, or a sensor attached to the battery pack 100, a replacement unit for detaching a discharged battery pack 100 from the vehicle or mounting a charged battery pack on the vehicle, a charging/discharging unit for charging/discharging and storing the battery pack 100, and a transfer unit for transferring a discharged battery pack 100, detached from the replacement unit, to the charging/discharging unit or transferring a battery pack 100 charged by the charging/discharging unit to the replacement unit.

As shown in FIGS. 3 and 4, the storage unit is divided into an area in which a plurality of stages is included so that battery packs can be stored depending on the type of battery pack 100 and in which buffer battery packs 110, each having a buffer capacity higher than a primary buffer capacity and replacing the discharged battery pack 100 for a vehicle, are stored and an area in which the ESS-dedicated battery packs 120, each having a buffer capacity smaller than the primary buffer capacity and used for an ESS, are stored.

Furthermore, as shown in FIGS. 4 and 6, the storage unit includes the second conveyance device 500, a third conveyance device 510, a transfer device 520, and a charging/discharging device 530.

A method of replacing a battery pack is described below with reference to FIG. 5

The replacement unit performs a task for replacing a discharged battery pack 100 with a charged battery pack 100 in relation to a vehicle that has been entered and waiting. As shown, the replacement unit replaces the discharged battery pack 100 with the fully charged battery pack 100 that has been provided based on the information of the determination unit.

More particularly, when a vehicle is entered, a replacement tool for detaching a discharged battery pack 100 from the vehicle is raised at step S20.

The locking of the discharged battery pack 100 is unclamped using the replacement tool at step S21.

Next, a safety device is opened at step S22.

Furthermore, the discharged battery pack 100 is detached and unloaded at step S23. Here, the discharged battery pack 100 is transferred to a first transfer device 400.

Next, a charged battery pack 100 taken over from a second transfer device 410, together with the replacement tool, is raised up at step S24.

The fully charged battery pack 100 is raised up and mounted at step S25.

Next, the safety device is closed at step S26.

Next, the replacement tool is lowered down to the original position at step 27.

Accordingly, the task of replacing the battery pack 100 is completed, and the vehicle is transferred to a safe area. Here, the discharged battery pack 100 detached from the vehicle and mounted on the replacement tool is transferred to the first transfer device 400. Thereafter, the replacement tool is moved by a first conveyance device 310, and thus the fully charged battery pack 100 is delivered to the second transfer device 410 and mounted on the vehicle.

As shown in FIGS. 6 and 7, regarding the ESS, first, a nation and a designated institution determine whether power needs to be supplied from ESS battery packs through a smart grid in emergency at step S30.

Next, when the amount of power to be transmitted by the ESS battery packs of each area is assigned, whether power of the buffer battery packs 110 will be transmitted based on the assigned amount is determined at step S31. If the amount of power to be transmitted is greater than a total amount of power of all the ESS-dedicated battery packs 120, the power of the buffer battery packs 110 is further added and transmitted.

When the power of the buffer battery packs 110 is transmitted, the charging of the buffer battery pack 110 is stopped and the amount of power to be transmitted is assigned at step S32. Here, the amount of power to be transmitted is assigned from the amount of power charged in the buffer battery packs 110.

Finally, the ESS-dedicated battery packs 120 and the buffer battery packs 110 are connected in series and in parallel based on the assigned amount of power, and power is converted and transmitted through a system line at step S33. Furthermore, power of all the ESS-dedicated battery packs 120 and some of or the entire power of the buffer battery pack 110 according to the assigned amount of power may be transmitted.

If a buffer battery pack 100 needs to be replaced with a charged battery pack because a vehicle has entered the replacement system while power is transmitted by the buffer battery pack 100, the replacement time may be extended depending on the number of remaining ESS batteries. For example, at normal times, the time taken to replace the battery pack 100 is about 1 minute 30 seconds to 1 minute 50 seconds. If some of ESS batteries, together with some of buffer batteries, send power to the system line, the time taken to replace a buffer battery may be doubled according to circumstances.

Furthermore, if power of the buffer battery pack 110 is not transmitted, the buffer battery pack 110 continues to be charged. If the amount of power is assigned at step S32-1, the amount of power to be transmitted from the amount of power charged in the ESS-dedicated battery pack 120 is assigned.

Finally, power from some of or all the ESS-dedicated battery packs 120 is converted based on the assigned amount of power and transmitted at step S33-1. Here, the charging/discharging device 530 calculates a capacity, prevents an error, controls the transmission and reception of power, and sends power by exchanging pieces of real-time information with the ESS-dedicated battery packs 120 and the buffer battery packs 110 through the smart grid.

[Mode of the Invention]

As described above, those skilled in the art to which the present invention pertains will understand that the present invention may be implemented in various detailed forms without changing the technical spirit or essential characteristics of the present invention. It will be understood that the above-described embodiments are illustrative and not limitative from all aspects. The scope of the present invention is defined by the appended claims rather than the detailed description, and the present invention should be construed as covering all modifications or variations derived from the meaning and scope of the appended claims and their equivalents.

What is claimed is:

1. A method of managing battery packs in a system equipped with a replacement system for replacing a battery pack for an electric vehicle and an Energy Storage System (ESS), the method comprising:
a tenth step S10 of detaching a discharged battery pack 100 from the electric vehicle;
an eleventh step S11 of delivering the detached discharged battery pack 100 to a charging/discharging line;
a twelfth step S12 of charging and storing the discharged battery pack 100;
a thirteenth step S13 of primarily checking a buffer capacity of the battery pack 100;
a fourteenth step S14 of classifying the battery pack 100 as a buffer battery pack 100 for replacement if, as a result of the check, the buffer capacity of the battery pack 100 is equal to and greater than a first buffer capacity reference;
a fifteenth step S15 of moving the battery pack 100 to an energy storage-dedicated line if, as a result of the check, the buffer capacity of the battery pack 100 is smaller than the first buffer capacity reference;
a fifteenth-first step S15-1 of secondarily checking the buffer capacity of the battery pack 100; and
a sixteenth step S16 of classifying the battery pack 100 as an ESS-dedicated battery pack 120.

2. The method of claim 1, further comprising:
a sixteenth-first step S16-1 of thirdly checking a buffer capacity of the ESS-dedicated battery pack 120 after the sixteenth step S16; and
a seventeenth step S17 of discarding the battery pack 100 if, as a result of the check, the buffer capacity of the battery pack 100 is smaller than the second buffer capacity reference.

3. A method of managing battery packs in a system equipped with a replacement system for replacing a battery pack 100 for an electric vehicle and an Energy Storage System (ESS), the method comprising:
a twentieth step S20 of raising a replacement tool for detaching a discharged battery pack 100 when the vehicle enters the system;
a twenty-first step S21 of releasing a locking of the discharged battery pack 100;
a twenty-second step S22 of opening a safety device;
a twenty-third step S23 of detaching the discharged battery pack 100 and unloading the discharged battery pack 100;
a twenty-fourth step S24 of raising a charged battery pack 100 using the replacement tool;
a twenty-fifth step S25 of mounting the charged battery pack 100 on the safety device;
a twenty-sixth step S26 of fastening the safety device to the charged battery pack 100; and
a twenty-seventh step S27 of lowering the replacement tool to its original position.

4. The method of claim 3, wherein the charged battery pack 100 comprises only a buffer battery pack 110.

5. A method of using a battery pack 100 for an electric vehicle in a system equipped with a replacement system for replacing the battery pack for the electric vehicle and an Energy Storage System (ESS), the system comprising:
a determination unit for determining a type of battery pack 100 of the vehicle;
a replacement unit for detaching a discharged battery pack 100 from the vehicle or mounting a battery pack on the vehicle;
a charging/discharging unit for charging/discharging and storing the discharged battery pack 100; and
a transfer unit for conveying the discharged battery pack, detached from the replacement unit, to the charging/discharging unit or conveying the battery pack 100, charged by the charging/discharging unit, to the replacement unit,
the method comprising:
a thirty-first step S31 of comparing an amount of power of ESS battery packs 110 with an amount of power to be transmitted when the amount of power to be transmitted that is necessary for an emergent power supply is assigned by a nation power management institution;
a thirty-second step S32 of assigning some of the ESS battery packs 110 and the buffer battery packs 120 if, as a result of the comparison, the amount of power of the ESS battery packs 110 is insufficient; and
a thirty-third step S33 of converting power of a plurality of the ESS-dedicated battery packs 120 and a plurality of the battery packs for battery 110 that are charged and stored and sending the power according to the assigned amount of power.

6. The method of claim 5, wherein:
the method further comprises a (32-1)^{th} step S32-1 of assigning some of the amount of power from the buffer battery packs 120 if the amount of power of the ESS battery packs 110 is insufficient at the thirty-first step S31; and
the system further comprises a control unit for controlling a time taken to mount a fully charged battery on the electric vehicle according to a ratio of the assigned buffer battery packs 120.

7. The method of claim 5, wherein the determination unit determines a battery pack using barcode, Bluetooth, or a sensor attached to the battery pack.

8. The method of claim 5, wherein the ESS-dedicated battery pack 120 and the buffer battery pack 110 are connected in series and in parallel to supply power to a system line.
